(19) United States
(12) Patent Application Publication
(10) Pub. No.: US 2012/0294793 A1
(43) Pub. Date: Nov. 22, 2012

(54) PRODUCTION OF GRAPHENE SHEETS AND RIBBONS

(75) Inventors: Weixing Chen, Edmonton (CA); Xinwei Cui, Edmonton (CA)

(73) Assignee: THE GOVERNORS OF THE UNIVERSITY OF ALBERTA, Edmonton (CA)

(21) Appl. No.: 13/475,729

(22) Filed: May 18, 2012

Related U.S. Application Data
(60) Provisional application No. 61/487,950, filed on May 19, 2011.

(51) Int. Cl. C01B 31/02; B01J 19/12; C01B 31/00; B01J 19/10; B82Y 40/00; B82Y 30/00

(52) U.S. Cl. 423/448; 204/157.42; 204/157.43; 977/734; 977/847; 977/948

(57) ABSTRACT

A method comprises: physically attaching one or more of metals, metal compounds or oxides to walls of carbon nanotubes; treating the metals, metal compounds or oxides to bond the metals, metal compounds, or oxides chemically to the carbon nanotubes; removing the metals, metal compounds or oxides from the walls of the carbon nanotubes resulting in defected carbon nanotubes; and unzipping the defected carbon nanotubes into graphene sheets or ribbons.

### CROSS-REFERENCE TO RELATED APPLICATIONS

This application claims the benefit under 35 USC 119(e) of U.S. provisional application Ser. No. 61/487,950 filed May 19, 2011.

### TECHNICAL FIELD

Carbon nanotubes.

### BACKGROUND

There are a number of processes reported for fabricating graphene materials. The current disclosure is a chemical-thermal process of unzipping carbon nanotubes to form carbon nano ribbons and graphenes. There are two existing chemical-thermal processes reported in the literature for unzipping CNTs to form graphenes. These two processes are all reported by the same research group at Rice University. Details of their processes are given below:

METHOD 1. Their earliest method [Nature 458, 877-880 (16 Apr. 2009)] starts with a two-stage procedure. The first stage is to unzip multi-walled carbon nanotubes (MWCNTs) into oxidized grapheme ribbons through oxidation. In this process, MWCNTs are suspended in concentrated sulphuric acid (H₂SO₄) for a period of 1-12 h and then treated with 500 wt % potassium permanganate (KMnO₄). The H₂SO₄ conditions aid in exfoliating the nanotube and the subsequent graphene structures. The reaction mixture was stirred at room temperature for 1 h and then heated to 55-70° C. for an additional 1 h. When all of the KMnO₄ had been consumed, the reaction mixture was quenched by pouring it over ice containing a small amount of hydrogen peroxide (H₂O₂). The solution was filtered over a polytetrafluoroethylene (PTFE) membrane, and the remaining solid was washed with acidic water followed by ethanol. The second stage is to reduce oxidized Nanoribbon into carbon graphene. This was done by treating a water solution (200 mg 121) of the above isolated nanoribbons (with or without 1 wt % SDS surfactant) with 1 vol % concentrated ammonium hydroxide (NH₄OH) and 1 vol % hydrazine monohydrate (N₂H₄—H20). Before being heating to 95° C. for 1 h, the solution was covered with a thin layer of silicon oil.

METHOD 2. Very recently the same group reported another method for the unzipping of CNTs (ACS Nano, 2011, 5 (2), pp. 968-974). It involved the reaction of MWCNTs with potassium. The synthesis of potassium split MWCNTs was performed by melting potassium over MWCNTs under vacuum (0.05 Torr) as follows: MWCNTs (1.00 g) and potassium pieces (3.00 g) were placed in a 50 mL Pyrex ampule that was evacuated and sealed with a torch. The reaction mixture was kept in a furnace at 250° C. for 14 h. The heated ampule containing a golden-bronze colored potassium intercalation compound and silvery droplets of unreacted metal was cooled to room temperature, opened in a dry box or in a nitrogen-filled glove bag, and then mixed with ethyl ether (20 mL). Ethanol (20 mL) was slowly added into the mixture of ethyl ether and potassium intercalated MWCNTs at room temperature with some bubbling observed; much of the heat release was dissipated by the released gas (hydrogen). The quenched product was removed from the nitrogen enclosure and collected on a polytetrafluoroethylene (PTFE) membrane (0.45 μm), washed with ethanol (20 mL), water (20 mL), ethanol (10 mL), ether (30 mL), and dried in vacuum to give longitudinally split MWCNTs as a black, fibrillar powder (1.00 g). The above process is followed by exfoliation of Potassium Split MWCNTs with Chlorosulfonic Acid. The potassium split MWCNTs tubes (10 mg) were dispersed in chlorosulfonic acid under bath sonication using an ultrasonic jewellery cleaner for 24 h. The mixture was quenched by pouring onto ice (50 mL), and the suspension was filtered through a PTFE membrane (0.45 μm). The filter cake was dried under vacuum. The resulting black powder was dispersed in dimethylformamide (DMF) and bath sonicated for 15 min to prepare a stock solution of graphene.

### SUMMARY

Disclosed is a method comprising: physically attaching one or more of metals, metal compounds or oxides to walls of carbon nanotubes; treating the metals, metal compounds or oxides to bond the metals, metal compounds, or oxides chemically to the carbon nanotubes; removing the metals, metal compounds or oxides from the walls of the carbon nanotubes resulting in defected carbon nanotubes; and unzipping the defected carbon nanotubes into graphene sheets or ribbons.

In a method of producing graphene sheets and ribbons, metals, metal compounds, and oxides are created that are at least physically attached to walls of carbon nanotubes (CNTs), the metals, metal compounds, and oxides are treated to bond the metals, metal compounds, and oxides chemically to the CNTs, the metals, metal compounds, and oxides are removed, resulting in defected CNTs and the defected CNTs are unzipped by for example sonication into grapheme sheets or ribbons.

Metals, metal compounds, and oxides may be physically attached by any of various means. A dip-casting approach is described in some detail, but other methods are possible. Treatment of the metals, metal compounds, and oxides to bond chemically to the CNTs may be performed by heating to a suitable temperature for a suitable time. The metals, metal compounds, and oxides may be removed by treatment with an acid or base, leaving the CNTs weakened, primarily along longitudinal lines. Sonication or other suitable disturbance generating methods unzip the CNTs into sheets or ribbons (depending on the length of the CNT).

A supercapacitor may be produced by the disclosed methods.

In various embodiments, there may be included any one or more of the following features: Physically attaching comprises dip-casting the carbon nanotubes into a fluid dispersion of the metals, metal compounds, or oxides, or dropping the fluid dispersion onto the carbon nanotubes. Dip-casting or dropping is followed by drying. Treating comprises heating the carbon nanotubes. Removing comprises contacting the carbon nanotubes with an acid or a base. Unzipping comprises exposing the defected carbon nanotubes to a disturbance generating method. The disturbance generating method comprises sonication. Sonication is carried out with the defected carbon nanotubes dispersed in a fluid, and further comprising filtering the fluid. The disturbance generating method comprises one or more of ball milling, microwave radiation, and scanning tunneling microscopy. Metals or metal compounds comprises one or more carbide forming metals. Carbide forming metals comprise one or more of Fe, Cr, V, Ti, and Mn. Repeating one or more stages. Repeating the treating and unzipping stages. Repeating the physically attaching and treating stages.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a series of images illustrating defected CNTs, specifically a) an atomic diagram; b) after dissolution of Mn-oxide nanoparticles; c) after dissolution of KOH followed by CNT/KOH reactions.

FIG. 2 is a series of images illustrated the morphologies of graphene materials converted from CNT arrays and random CNTs, specifically: a) and b) graphene nanoribbons; (c) wrinkled graphene sheets; and (d) graphene paper.

### DETAILED DESCRIPTION

Immaterial modifications may be made to the embodiments described here without departing from what is covered by the claims.

Disclosed is a method of producing graphene sheets or ribbons. Some embodiments are described as follows:

One or more of metals, metal compounds or oxides are physically attached to walls of carbon nanotubes, for example by dip-casting the carbon nanotubes into a fluid dispersion of the metals, metal compounds, or oxides, or dropping the fluid dispersion onto the carbon nanotubes.

(1) As-fabricated carbon nanotube arrays (CNT arrays), or any purified random carbon nanotubes (CNTs) may be used in this stage. The carbon nanotubes may be either single walled or multi-walled. The length of carbon nanotubes may not be a factor and pre-dispersing of carbon nanotubes may not be required.

(2) Place the CNT materials on a substrate that allows liquid draining and drying.

(3) Soak CNT arrays or random CNTs with manganese acetate [C₆H₉MnO₆.2(H₂O)]— ethanol solution through solution dropping. In this stage, alternate solutions could be found in our previous patent application. Basically, the organic liquids, such as ethanol, acetone, ethylene glycol, etc., may be used to produce alternate metals, metal compounds, and oxides on the CNT surface. A list of alternative metals, metal compounds, and oxides that may be used to attach to CNT arrays and the process required for metals, metal compounds, and oxide formation are disclosed below. Other methods may be used to physically attach the chemicals to the CNTs, for example dip-casting.

(4) Dry the soaked CNT arrays or CNT pileups in air for at least 1 hour.

The metals, metal compounds or oxides are then treated, for example using heating, to bond the metals, metal compounds, or oxides chemically to the carbon nanotubes.

(5) Anneal CNT materials after Stage 4 at 300° C. for 2 hours in air to form Mn₃O₄ nanoparticles on the CNT external surface. This annealing may serve two purposes: 1) forming nano-oxide particles uniformly on the surface of CNTs, 2) achieving chemical reactions between metals, metal compounds, and oxide particles formed on CNTs and carbon atoms of CNTs at the locations with attached metals, metal compounds, and oxides.

(6) In order to achieve some chemical reactions between carbon atoms of CNTs and metals, metal compounds, and oxides attached, the annealing conditions may be adjusted according to the type of metals, metal compounds, and oxides. The annealing may also be performed in a controlled environment to prevent de-composition of CNT structures or to assist the reaction between metals, metal compounds, and oxides and carbon atoms of CNTs.

(7) The type of metals, metal compounds, and oxides to be attached may be selective. In general, oxides of those metals that are also strong carbide-formers are highly recommended. Carbide-forming metals include but not limit to Fe, Cr, V, Ti, Mn.

(8) Alternative methods to form metals, metal compounds, and oxides on CNTs may be also available for random CNTs and CNT arrays, for example, electroplating, barrel plating, chemical plating (also called electroless plating). Sputtering, atomic layer deposition, chemical vapor deposition, etc., may also be used for forming metals, metal compounds, and oxides. However these methods may not yield a uniform coverage of metals, metal compounds, and oxides on the surface of CNTs .

(9) Functionalization of CNT arrays or random CNTs may be necessary in alternative methods to form oxides on CNTs. For example, in order to electrodeposit oxide particles on random CNTs in aqueous electrolytes, random CNTs may be needed to be functionalized with hydrophilic groups. After this hydrophobic to hydrophilic conversion, random CNTs are able to be well dispersed in aqueous plating electrolytes before electroplating.

(10) After forming oxide particles on CNTs using alternative methods, annealing may be necessary according to Stages 5 and 6.

The metals, metal compounds or oxides are then removed from the walls of the carbon nanotubes, for example by contacting the carbon nanotubes with an acid or a base, resulting in defected carbon nanotubes.

(11) Chemical reactions can be achieved between carbon atoms of CNTs and strong bases (e.g., NaOH, KOH, etc.). One example is to mix random CNTs or CNT arrays with KOH homogeneously, heat the mixtures to 500-1000° C. for 0.1-5 hours in an Argon protected environment and cool down to room temperature. Microwave irradiation may also work for this type of chemical reaction.

(12) Dissolve Mn₃O₄ nanoparticles, other decorated oxides, or strong bases on CNTs in concentrated HNO₃ solution at 70° C. for 3 hour by refluxing. Any acid and some alkali (depending on the type of metals, metal compounds, and oxide particles) are able to dissolve the nanoparticles. However, a strong acid may be better.

(13) Stage 12 may be conducted by using diluted or concentrated HNO₃ solution at room temperature, to affect the oxygen content in the unzipped CNTs, graphene nanoribbons, or wrinkled graphene sheets.

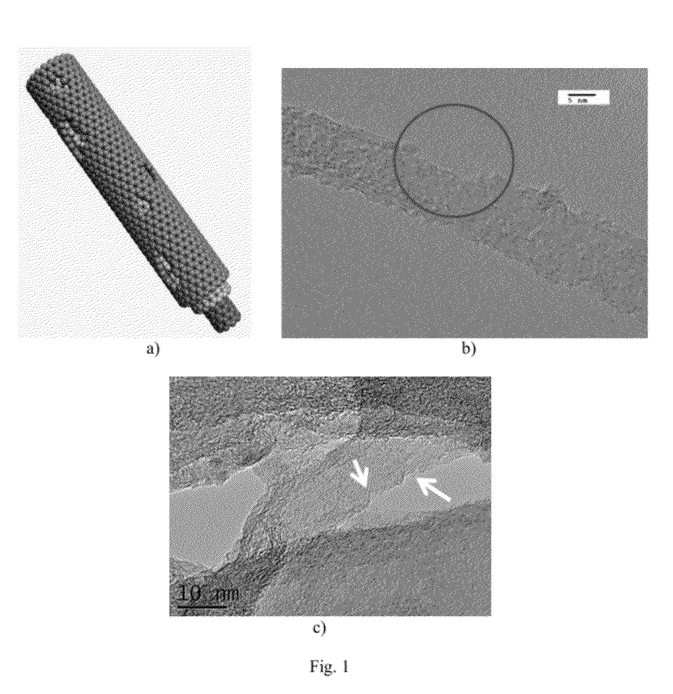

(14) The dissolution of metals, metal compounds, and oxides is also accompanied with a removal of carbon atoms that had reacted with metals, metal compounds, and oxides/bases during the annealing applied prior to the dissolution. This will create defects on the surface of CNTs. The defects may be also extended to the inner tubes of multiwall CNTs. An example of defected CNTs after Stages 12 and 13 is shown in FIG. 1.

The defected carbon nanotubes are then separated (unzipped) into graphene sheets or ribbons, for example by exposing the defected carbon nanotubes to a disturbance generating method such as sonication. Other suitable disturbance generating methods may be used such as ball milling, microwave radiation, and scanning tunneling microscopy.

(15) Disperse CNT arrays or random CNTs obtained after Stages 12 to 14 in N-Methyl-2-pyrrolidone (NMP) by sonication for over 30 min. The NMP solution obtained is a stock of graphene nanoribbon solution. Solutions that could be used during sonication are benzyl benzoate, γ-Butyrolactone (GBL), N,N-Dimethylacetamide (DMA), 1,3-Dimethyl-2-Imidazolidinone (DMEU), 1-Vinyl-2-pyrrolidone (NVP), 1-Dodecyl-2-pyrrolidinone (N12P), N,N-Dimethylformamide (DMF), Dimethyl sulfoxide (DMSO), Isopropanol (IPA), 1-Octyl-2-pyrroldone (N8P); ionic liquids (ILs), e.g., 1-Ethyl-3-methylimidazolium tetrafluoroborate ([EMIM][BF4]); ethanol, acetone, ethylene glycol, water, etc. The sonication will cause unzipping of CNTs from the defected sites.

(16) High energy sonication, such as tip sonication at high power, facilitates unzipping processes.

One or more stages may be repeated.

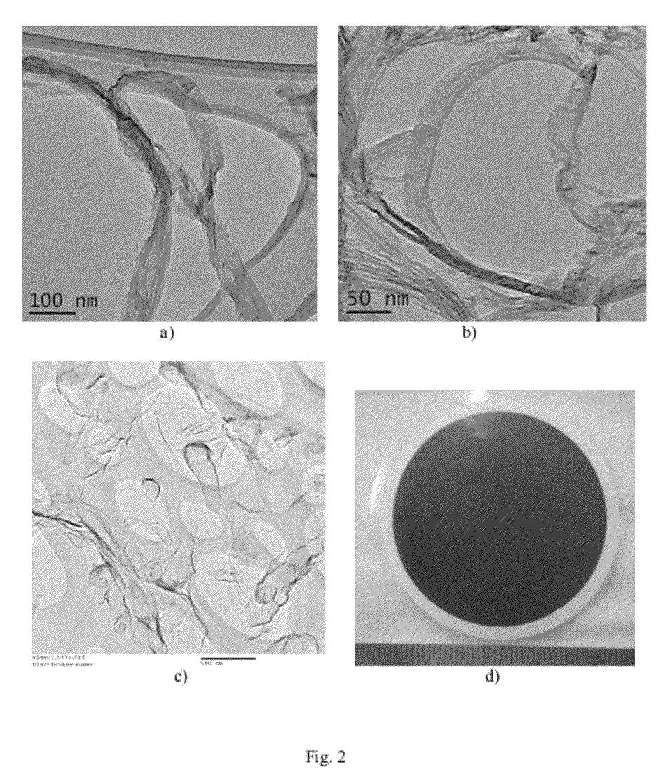

(17) The yield of graphene nanoribbon (FIG. 2a) from the above described CNT-unzipping process may be varied depending on the processes described in Stage 3 to 11. The physically attaching and treating stages may be repeated. For example, to achieve 100% unzipping of CNTs, Stages 3 to 5, Stages 8 to 10, or Stage 11 may be repeated for a number of times, for example, repeating Stage 3 at least 20 times before stage 4, or repeating Stage 3 after Stage 4. Repeating of Stages 3 to 5, Stages 8 to 10, or Stage 11 can be conducted after Stage 12 and 13. 100% unzipping is usually obtained when CNTs are homogeneously covered with a thin layer of nanoparticles, or homogeneously reaction with bases.

(18) Partially unzipping of CNT arrays or random CNTs yields graphene nanoribbon/CNT hybrids.

(19) Unzipping of long CNTs (typically CNTs in millimeter-long CNT arrays) tend to form wrinkled graphene sheets.

(20) The treating and unzipping stages may be repeated. For example, to unzip long CNTs, an additional post-oxidation process may be used, e.g., annealing the obtained carbon materials in Stage 12 or Stage 13 without repeating Stage 3 and Stage 4, to a high temperature (in the range of 150˜600° C.) in air. After further sonication, the carbon materials may be completely unzipped to wrinkled graphene sheets (FIG. 2b).

(21) After sonication is carried out with the defected carbon nanotubes dispersed in a fluid, the fluid may be filtered. The graphene nanoribbon dispersed solution may be filtered to form a single piece of graphene nanoribbon paper varied dimensions depending on the size of filtering area (FIG. 2c).

(22) The graphene nanoribbon/CNT hybrid dispersed solution may be filtered to form a single piece of graphene nanoribbon/CNT hybrid paper varied dimensions depending on the size of filtering area.

(23) The wrinked graphene sheet dispersed solution from long CNTs may be filtered to form a single piece of wrinkled graphene sheet paper varied dimensions depending on the size of filtering area.

(24) Hybrids of graphene nanoribbons, graphene sheets and/or CNTs may be achieved from the alternating filtration of solutions containing different carbon nanomaterials, forming multi-layered papers.

The disclosed methods may be used to produce a supercapacitor, discussed further below.

With existing methods long CNT arrays, after particle dissolving and sonication, the obtained structure is CNT/graphene hybrids, which is partially unzipped CNTs. The amount of graphene included may be modified through sonication power and duration. However, the CNTs may not be fully unzipped.

Applicants have found that an additional post-oxidation process may be used, e.g., annealing the obtained hybrids to a high temperature (less than 500° C.). After further sonication, the CNTs would be completely unzipped (compared with 2% unzipping using calcining in air) to produce curved graphenes, also called twisted graphene nanoribbons. This two-stage procedure may be applied to all other kinds of CNTs, such as short CNTs. For well-crystalline short CNTs, the first stage only may be enough to get the CNTs fully unzipped. The differences when unzipping different types of CNTs by the disclosed procedure may be the relatively greater amount of defects and the morphology of the final obtained graphenes.

The methods disclosed herein are applicable to metals, metal compounds, or oxides of metals for which one of the salts of that metal may be dissolved within non-aqueous solution (e.g. ethanol). Basically, the organic liquids, such as ethanol, acetone, ethylene glycol, etc., may be used to produce alternate oxides on the CNT surface. Metal oxides for which the above method may be applied include LiOₓ, MgOₓ CaOₓ TiOₓ, CrOₓ, MnOₓ FeOₓ CoOₓ, NiOₓ, CuOₓ, VO_{N}, ZnOₓ, ZrOₓ, NbOₓ, TaOₓ, MoOₓ, RuOₓ, AgOₓ, SnOₓ, SbOₓ, CeOₓ, LaOₓ, PdOₓ, YOₓ, Tin-doped Indium oxide, and InOₓ. Metals for which the above method may be applied include Li, Mg, Ca, Ti, Cr, Mn, Fe, Co, Ni, Cu, Ni/Cu alloy, V, Zn, Zr, Nb, Ta, Mo, Ru, In, Sn, Sb, Ag, Au or Pd. Metal compounds for which the above method may be applied include LiOH, MgSO₄, CaCO₃, NiCO₃, or LaO₂CO₃. It can be soundly predicted that the disclosed methods will work with these and other metals, metal compounds, and oxides, because the chemical properties of the materials are sufficiently similar to the tested materials that the materials can be predicted to attach to CNTs. Once attached, these chemicals will upset the molecular structure of the CNTs. It is further soundly predictable, due to the similarity of the bonds created for the disclosed example and the other materials, that when removed from the CNTs, for example by dissolution in acid, the structure of the CNT will remain defected instead of spontaneously reverting to the previous undefected structure. The defected CNTs can then be unzipped for example by exposure to disturbance generating methods, which supply the energy needed to unzip the CNT along the strained bonds holding the CNT in tubular formation.

LiOH, Li, Li₂O. (1) Dissolve LiOH in ethanol, and dip the solution into the CNTAs. This structure may be used for CO₂ capture. (2) Dissolve LiCH₃COO in ethanol and dip the solution into the CNTAs. When heated to 70 to 700° C., LiCH₃COO would decompose to form Li metal or Li₂O, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)).

MgO, Mg. (1) Dissolve Mg(CH₃COO)₂ in ethanol, and dip the solution into the CNTAs. When heated to 80 to 700° C., Mg(CH₃COO)₂ would decompose to form MgO and Mg, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)). (2) MgSO₄ would also work.

CaCO₃, CaO, Ca. Dissolve Ca(CH₃COO)₂ in methanol, and dip the solution into the CNTAs. When heated to 160 to 700° C., Ca(CH₃COO)₂ would decompose to form CaCO₃, CaO and Ca, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)).

TiO₂, TiO, Ti₂O₃, Ti. Dissolve titanium isopropoxide or titanium ethoxide in ethanol, and dip the solution into the CNTAs. When heated to 100 to 700° C., titanium isopropoxide or titanium ethoxide would decompose to form TiO₂, TiO, Ti₂O₃ and Ti, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)).

CrO₂, Cr₂O₃, CrO, Cr. Dissolve chromium dimethylamino ethoxides in ethanol, and dip the solution into the CNTAs. When heated to 100 to 700° C., chromium dimethylamino ethoxides would decompose to form CrO₂, Cr₂O₃, Cr0 and Cr, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)).

MnO, Mn₂O₃, Mn₃O₄, Mn. Dissolve Mn(CH₃COO)₂ in ethanol, and dip the solution into the CNTAs. When heated to 150 to 700° C., Mn(CH₃COO)₂ would decompose to form MnO, Mn₂O₃, Mn₃O₄ and Mn, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)). The remaining method stages were carried to completion on the resulting functionalized CNTs to produce graphene sheets and ribbons.

FeO, α-Fe₂O₃, γ-Fe₂O₃, Fe₃O₄, Fe. Dissolve Fe(CH₃COO)₂ or Fe(CH₃COO)₃ in ethanol, and dip the solution into the CNTAs. When heated to 140 to 700° C., Fe(CH₃COO)₂ or Fe(CH₃COO)₃ would decompose to form FeO, α-Fe₂O₃, γ-Fe₂O₃, Fe₃O₄ and Fe, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)).

CoO, Co₂O₃, CO₃O₄, Co. Dissolve Co(CH₃COO)₂ in ethanol, and dip the solution into the CNTAs. When heated to 140 to 700° C., Co(CH₃COO)₂ would decompose to form CoO, Co₂O₃, Co₃O₄ and Co, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)).

NiCO₃, NiO, Ni. Dissolve Ni(CH₃COO)₂ in ethanol, and dip the solution into the CNTAs. When heated to 200 to 700° C., Ni(CH₃COO)₂ would decompose to form NiCO₃, NiO and Ni, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)).

Cu₂O, CuO, Cu. Dissolve Cu(CH₃COO)₂ in ethanol, and dip the solution into the CNTAs. When heated to 115 to 700° C., Cu(CH₃COO)₂ would decompose to form Cu₂O, CuO and Cu, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)).

VO₂, V₂O₅, V₂O₃, VO, V. Dissolve vanadium alkoxide molecular precursors in ethanol, and dip the solution into the CNTAs. When heated to 200 to 700° C., the precursors would decompose to form VO₂, V₂O₅, V₂O₃, VO, and V, depending on the heating temperature and environment (inert gases (e.g., N₂, Ar), reducing gases (e.g., H₂, Ar/H₂, N₂/H₂, CO) and oxidation gases (e.g., air, O₂, Ar/O₂, N₂/O₂)).

ZnO, Zn. Dissolve Zn(CH₃COO)₂ in ethanol, and dip the solution into the CNTAs. When heated to 237 to 700° C., Zn(CH₃COO)₂ would decompose to form ZnO nanoparticles, ZnO nanowires, and Zn, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)).

ZrO₂, Zr: Dissolve Zr(CH₃CH₂COO)₄ in ethanol or isopropanol, and dip the solution into the CNTAs. When heated to 200 to 700° C., Zr(CH₃CH₂COO)₄ would decompose to form ZrO and Zr, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)).

Nb₂O₅, Nb. Dissolve ammonium niobium oxide oxalate hydrate or niobium oxalate in ethanol, and dip the solution into the CNTAs. When heated to 200 to 700° C., the solute would decompose to form Nb₂O₅ and Nb, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)).

Ta₂O₅, Ta. Dissolve Tantalum alkoxides in ethanol, and dip the solution into the CNTAs. When heated to 200 to 700° C., Tantalum alkoxides would decompose to form Ta₂O₅ and Ta, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)).

MoO₃, Mo. Dissolve Mo(CH₃COO)₂ in ethanol, and dip the solution into the CNTAs. When heated to 200 to 700° C., Mo(CH₃COO)₂ would decompose to form MoO₃ and Mo, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)).

RuO₂, Ru. Dissolve Ru(CH₃COO)₂ in ethanol, and dip the solution into the CNTAs. When heated to 200 to 700° C., Ru(CH₃COO)₂ would decompose to form RuO₂ and Ru, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)).

Ag₂O, Ag. Dissolve Ag(CH₃COO) in ethanol, and dip the solution into the CNTAs. When heated to 200 to 700° C., Ag(CH₃COO) would decompose to form Ag and Ag₂O, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)).

SnO₂, SnO, Sn. Dissolve SnC1₄ in ethanol, and dip the solution into the CNTAs. When heated to 150 to 700° C., Ag(CH₃COO) would decompose to form SnO₂, SnO, and Sn, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)).

Sb₂O₃, Sb. Dissolve Sb(CH₃COO)₃ in ethanol, and dip the solution into the CNTAs. When heated to 200 to 700° C., Sb(CH₃COO)₃ would decompose to form Sb₂O₃ and Sb, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)).

CeO₂. Dissolve Ce(CH₃COO)₃ in ethanol, and dip the solution into the CNTAs. When heated to 200 to 700° C., Ce(CH₃COO)₃ would decompose to form CeO₂, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)).

La₂O₂CO₃, La₂O₃. Dissolve La(CH₃COO)₃ in ethanol, and dip the solution into the CNTAs. When heated to 150 to 700° C., La(CH₃COO)₃ would decompose to form La₂O₂CO₃ and La₂O₃, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)).

PdO, Pd. Dissolve PdC1₂ in ethanol, and dip the solution into the CNTAs. When heated to 150 to 700° C., PdC1₂ would decompose to form PdO and Pd, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)).

Y₂O₃. Dissolve Y(CH₃COO)₃ in ethanol, and dip the solution into the CNTAs. When heated to 200 to 700° C., Y(CH₃COO)₃ would decompose to form Y₂O₃, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)).

In₂O₃, Tin-doped indium oxide (ITO), In. (1) Dissolve In(CH₃COO)₃ in ethanol, and dip the solution into the CNTAs. When heated to 200 to 700° C., In(CH₃COO)₃ would decompose to form In₂O₃ and In, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)). (2) Dissolve In(CH₃COO)₃ and SnC1₄ in ethanol, and dip the solution into the CNTAs. When heated to 200 to 700° C., the solutes would decompose to form ITO, depending on the heating temperature and environment (inert gases (e.g., N₂, Ar), reducing gases (e.g., H₂, Ar/H₂, N₂/H₂) and oxidation gases (e.g., air, O₂, Ar/O₂, N₂/O₂)).

Au. Dissolve the diblock copolymer [polystyrene8100-block-poly(2-vinylpyridine)14200] in toluene. Add HAuC14^{.}₃H₂O into the solution to form gold particle precursors. Dip the precursors into the CNTAs. When heated to 200 to 700° C., the solutes would decompose to form Au.

The non-aqueous solvent is not limited to ethanol. The metallic salts that used as precursors are not limited to metal acetates.

After dip-casting, the electroplating method in aqueous or non-aqueous electrolytes may be used to deposit more forms and morphologies of oxides or metallic elements into CNTAs, for example, MnO₂, Ni/Cu alloys, etc.

In the disclosed dip-casting method, an oxide precursor, such as manganese acetate, in a carrier liquid, such as ethanol, may be brought into contact with a CNT array and the carrier removed to leave the oxide precursor physically in contact with the CNTs in the CNT array Annealing of the CNTs causes the oxide precursor to bind chemically with the CNTs to form metal oxide particles chemically bonded (dispersed) within the CNT array. In the case of random CNTs, other methods may be used to form CNTs decorated with oxides that are chemically bonded to the CNTs by first bringing the metal oxide precursor into physical contact with the CNTs and then annealing the CNTs to cause a chemical bonding of the metal oxide to the carbon atoms of the CNTS. Methods for bringing the oxide precursor into contact with the random CNTs include electroplating, sputtering, chemical vapor deposition, atomic layer deposition and physical vapor deposition. Annealing may be effected by heating the oxide precursor to a temperature and for a time sufficient to cause chemical bonding of the oxide to carbon atoms of the CNT, without destroying the CNT. If the metal oxide precursor does not already provide oxygen for bonding, the process may be carried out in the presence of free oxygen.

The oxides may then be removed, weakening the CNTs, and sonication or application of other suitable disturbances to the CNTs causes the CNTs to separate into sheets or ribbons. Suitable disturbances include ball milling and microwave radiation. Unzipping with Tunneling Microscope tip using scanning tunneling microscope, peeling or plasma etching may also be used but these latter three methods may not unzip large amount of CNTs at a time.

The disclosed methods may apply in particular to multiwalled carbon nanotube arrays (CNTAs), that is, we may convert the as-fabricated CNTAs directly into nano-ribbons or graphene sheets.

Based on the studies undertaken, it is believed that unzipping occurs during sonication after coated materials are dissolved. Embodiments of the disclosed methods may enable a formation of continuous oxide coverage on CNTs and produce a yield of at least 50% and up to 100%. We use oxides to react directly with CNTs. The oxides will be completed dissolved. We create defects to enhance the unzipping. This helps in the making of supercapacitors.

Various embodiments of the methods achieve one or more of the following advantages. Not too many stages and short processing time. Few consumable chemicals for processing and the chemicals used in the process may be re-used. The process requires a treatment at temperature treatments (for example ˜300° C. for annealing; 20˜70° C. for acid treatments), and is able to open ultra-long carbon nanotubes to make graphene nanoribbons and graphene sheets. The process may yield a high quality of unzipped CNTs with different characteristics, such as: a) Completely unzipped multiwall CNTs to yield pure carbon nanoribbons, b) Partially unzipped multiwall CNTs to produce hybrid of carbon nanoribbons and CNTs, and c) Unzipped CNTs with different degree of defects on carbon nano-ribbons or graphene sheets, which may be important to the performance of electrodes for supercapacitors or other applications.

Coin cell supercapacitors developed are made possible due to the following three technologies: (1) Fabrication of ultra-long multiwall carbon nanotube arrays (CNTA), for example disclosed in PCT publication no. WO2012019309 and incorporated by reference. (2) Hydrophilic conversion and nanoparticle decoration of CNTAs for example disclosed in PCT publication no. WO2011143777 and incorporated by reference. This technology is a process to modify the as-fabricated large size hydrophobic CNTAs into hydrophilic CNTAs without destroying their array morphology and structure. Because of hydrophilic nature, chemical and electro-chemical processing the modified CNTAs in aqueous solutions for attaching CNTAs with functional catalyst particles for various applications become possible. The CNTAs may be further processed into flexible thin composite papers with extremely high electric conductivities. The paper composites loaded with catalyst particles may be used directly as electrodes without the need to use binders and current collectors that are necessary for some other supercapacitor technologies reported. (3) A process that may convert ultra-long CNTAs into graphene nanoribbons and graphene sheets as disclosed in this document. Both the graphene nano-ribbons and graphene sheets may be further processed into large size graphene papers.

In an embodiment of a dip-casting process, we first attach Mn₃O₄ nanoparticles to CNTs. We believe that this is not a simple attachment and it may involve a reaction between Mn₃O₄ and Carbon atoms from CNTs. This was followed by a process to dissolve Mn₃O₄ particles. The dissolution of the particles creates “holes” on the CNT. These holes were made not only on the first layer of the tubes but also on all the walls of the MWCNTs. These holes may be vibrated to open for fully unzipping the CNTs. This also suggests that Mn₃O₄ particles in our process were not simply glued to the surface of CNTs but embedded through CNT walls, an indication of chemical reaction. During the subsequent process of Mn₃O₄-particle dissolution, carbon atoms at the site where Mn₃O₄ particles were attached were removed or dissolved together with the Mn₃O₄ particles to form holes on CNTs. Because of the reaction of oxide particles with Carbon atoms in CNTs, we believe that other oxides may serve as the same purpose as Mn₃O₄ particles in unzipping CNTs. Because of substantial differences in unzipping CNTs, our carbon nanoribbons may be much more defected—a good thing for making supercapacitors but may not be ideal for electronic applications.

TABLE 1
Resistivity of MWCNT- and graphene-papers

| Materials | Resistivity (Ohm * cm) | Reference |
|---|---|---|
| MWCNT paper | 0.02-0.1 | Yang, K. et al. Journal of |
| | | Physics: Condensed |
| | | Matter, 22, 2010, 334215 |
| Graphene paper | 0.033~0.5 | Compton, O. C. et al. |
| | | Advanced Materials, 22, |
| | | 2010, 892 |
| University of | 0.00656 | University of Alberta |
| Alberta ultra-long | (3~15 times lower) | |
| MWCNT paper | | |

Currently ultra-long CNTAs are not commercially available, although random CNTs may be purchased in the market. The CNTAs may be fabricated using a simple horizontal tubular furnace with a diameter of about 80 mm. This furnace may grow high quality CNTAs with a maximum dimension of 20 mm×20 mm. For a full size storage unit, it is expected that a single piece CNTA with a dimension of one full size CD disk of about 12 cm in diameter would be adequate for most applications. This is also the size of sputtered catalyst film that may be produced in the department. This single piece of CNTA may be converted into the same dimension CNTA composite paper. The conversion technique is not limited by CNTA dimensions. Therefore, a key challenge is to fabricate large size CNTAs with good uniformity.

To achieve the objective, a vertical tubular furnace may be used with reaction gases flowing from the top of the tube furnace and the substrate for CNTA growth facing the flow of reaction gas mixture. The time to grow one ultra-long CNTA with CNT heights best for energy storage is usually less than 30 minutes. The furnace may be designed allowing a continuous fabrication of large size CNTAs. The required production lines for processing CNTAs into electrodes used for large size supercapacitors may be based on the disclosed methods.

Technologies to fabricate the following four different types of electrodes for supercapacitors. All of these electrodes are free of binding materials and current collector because of adequate mechanical properties of the electrodes required during processing and excellent electric conductivity that are associated with long fibrous nature of ultra-long CNTs used. (1) Ultra-thin CNTA papers processed directly from CNTAs. (2) Graphene nanoribbon papers fabricated through filtration of nanoribbon-containing solutions. (3) Hybrid CNT and nanoribbon papers fabricated through filtration of partially unzipped multiwalled CNT-containing solutions. (4) Graphene papers fabricated through filtration of graphene sheet-containing solutions

All the above thin sheet structures may be further processed to introduce 1) more nano-size defects on the surface of CNTs, nanoribbons or graphenes, 2) to attach functional groups or nano-catalyst particles. Such a modification may substantially increase energy density and may yield some effect on power density or cyclicability of the supercapacitors. Therefore, structural optimization in terms of arranging and stacking electrodes with various properties as indicated above is needed in order to achieve large capacity of energy storage and at the same time to maintain high power density and cyclicability of the large size supercapacitor units.

Examples of these functional groups are carboxylic acid groups (—COOH), amine groups (—NH₂), etc. The easiest way to functionalize these groups to the defects are using chemical reactions that occurring between functional-group-containing precursor and our unzipped CNTs. One example of this reaction is, in order to functionalize unzipped CNTs with —COOH, unzipped CNTs may be refluxed in concentrated H₂SO₄/HNO₃. If going further to functionalize —NH₂, carboxylated unzipped CNTs may be chlorinated with SOCl₂ and then react with NH₂(CH₂)₂NH₂. There are also many other ways to attach these two functional groups.

The performance of individual paper-form electrodes has been determined. For commercial production, optimized performance of a large unit, with a balance between high energy density and power density, which should be optimized based on the type of applications.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A method comprising:
physically attaching one or more of metals, metal compounds or oxides to walls of carbon nanotubes;
treating the metals, metal compounds or oxides to bond the metals, metal compounds, or oxides chemically to the carbon nanotubes;
removing the metals, metal compounds or oxides from the walls of the carbon nanotubes resulting in defected carbon nanotubes; and
unzipping the defected carbon nanotubes into graphene sheets or ribbons.

2. The method of claim 1 in which physically attaching further comprises dip-casting the carbon nanotubes into a fluid dispersion of the metals, metal compounds, or oxides, or dropping the fluid dispersion onto the carbon nanotubes.

3. The method of claim 2 in which dip-casting or dropping is followed by drying.

4. The method of claim 1 in which treating further comprises heating the carbon nanotubes.

5. The method of claim 1 in which removing further comprises contacting the carbon nanotubes with an acid or a base.

6. The method of claim 1 in which unzipping further comprises exposing the defected carbon nanotubes to a disturbance generating method.

7. The method of claim 6 in which the disturbance generating method comprises sonication.

8. The method of claim 7 in which sonication is carried out with the defected carbon nanotubes dispersed in a fluid, and further comprising filtering the fluid.

9. The method of 6 in which the disturbance generating method comprises one or more of ball milling, microwave radiation, and scanning tunneling microscopy.

10. The method of claim 1 in which metals or metal compounds comprises one or more carbide forming metals.

11. The method of claim 10 in which carbide forming metals further comprise one or more of Fe, Cr, V, Ti, and Mn.

12. The method of claim 1 further comprising repeating one or more stages.

13. The method of claim 12 further comprising repeating the treating and unzipping stages.

14. The method of claim 12 further comprising repeating the physically attaching and treating stages.

15. A supercapacitor produced by the methods of claim 1.
